(19) United States
(12) Patent Application Publication
(10) Pub. No.: US 2020/0104543 A1
(43) Pub. Date: Apr. 2, 2020

(54) METHOD FOR EVALUATING TEMPERATURES IN ACTIVE HEAVE COMPENSATION ROPES

(71) Applicant: REDAELLI TECNA S.P.A., Milano (IT)

(72) Inventors: Francesco Foti, Milano (IT); Maurizio Meleddu, Gardone Val Trompia (BS) (IT); Luca Martinelli, Milano (IT)

(73) Assignee: REDAELLI TECNA S.P.A, Milano (IT)

(21) Appl. No.: 16/497,195

(22) PCT Filed: Apr. 3, 2018
(86) PCT No.: PCT/EP2018/058476

§ 371 Date: Sep. 24, 2019

(30) Foreign Application Priority Data
Apr. 4, 2017 (EP) 17164706.8

(51) Int. Cl. G06F 30/20; G06F 17/12; E21B 47/06

(52) U.S. Cl. CPC G06F 30/20; G06F 2111/10; E21B 47/065; G06F 17/12

(57) ABSTRACT

Method for evaluating temperatures in active heave compensation ropes comprising the following steps: describe the geometry of ropes as composite structures obtained through assemblies of helical components in hierarchical levels: wires, strands and the rope itself; use a mechanical model of the strand that represents the material properties of each wire, under the assumption of linear elastic behavior; use a mechanical model of the rope that represents the combined action of tensile loads and imposed bending curvature; use a thermal model for the evaluation of the rope temperature increase (Ts) with respect to the ambient temperature, the thermal model comprising two main dissipation sources: the friction between strands or rope and a sheave and the friction between wires or between strands and compare rope temperature increase (Ts) obtained by the thermal model with a value of a predetermined temperature threshold.

### BACKGROUND OF THE INVENTION

### 1. Field of the Invention

The present invention relates to a method for evaluating temperatures in active heave compensation ropes. In particular, the present method measures the temperature generated, due to rope's back-and-forth movement over a sheave in operation's speed and analyzes the consequences of applying thermal fields on wires.

### 2. Brief Description of the Prior Art

As it is known, the wire ropes or, simply, ropes were widely used for subsea installations, however, in the recent years there has been a dramatic increase in the requests for wire ropes capable to withstand harsher work conditions. The users need larger and longer wires ropes which can undergo heavier works and loads. All these has forced the wire rope manufacturers to take part in this quest of better, bigger and more mighty to tackle the ever-larger dynamic loads and the more extreme bending cycles. Active Heave Compensation system (AHC) is one of the factors influencing the most, life expectancy of wire ropes in Abandonment and Recovery applications. AHC is used in order to keep the loads stable with respect to the seabed by undermining the water and thus the vessel's movements due to the offshore climate.

These continuous back and forth rope movements with respect to the point of equilibrium induce extra stresses on the rope, which are caused by repeated stretching and bending, as well as dynamic loading. These lead to a wear, fatigue and temperature increment on the same portion of the rope, while the payload is static with respect to the seabed. The fatigue damages characteristics of steel wire rope throughout its service life, which has been topic of an in-depth study by Schrems K.“Wear-Related Fatigue in a Wre Rope Failure” Journal of Testing and Evaluation, Vol. 22, No. 5, 1994, pp. 490-499″ have been carried out during the years on the smaller ropes while there is a lack of information and studies on larger diameters, moreover, the effect of temperature on the mechanical behavior of the ropes has not been tackled in-depth yet.

The process leading the variation of mechanical properties on high carbon drawn steel wire has been largely investigated for years. Nevertheless, none of the known method are concentrated on the investigation of specific window of interest in terms of temperature and related mechanism leading the heating generation.

### SUMMARY OF THE INVENTION

Aim of the present invention is to provide a method for evaluating the amount of heating generated on a rope during an intense use of AHC. Under thermal cycling exposition, the high-hardened drawn wires undergo changes in their mechanical properties. These characteristics are the Breaking Strength (Rm), Yield Strength (Rp02) and the Elongation at break (Ez), defined as:

Ez=100 (L−L0)/L0 where L0 is the initial length of the wire and L is the length of the wire at break.

The investigation of these changes highlights a faster deterioration of material's ductility when the wires are exposed to a thermal field, generally within the range of 50° C. to 150° C. (according to data gathered from the field).

An aspect of the invention is therefore a method to investigate how a thermal influence within the mentioned range of temperature (in accordance to the data coming from the field) induces a fast deterioration of ductility. In particular, the method evaluates the temperature reached by the rope and compares such temperature with a predetermined temperature threshold above which the fast deterioration of ductility is reached.

According to the present invention, a method for evaluating temperatures in active heave compensation ropes is described, the method having the characteristics as in the enclosed independent claim.

Further embodiments of the invention, preferred and/or particularly advantageous, are described according to the characteristics as in the enclosed dependent claims.

### BRIEF DESCRIPTION OF THE DRAWINGS

The invention will be now described by reference to the enclosed drawings, which show some non-limitative embodiments, namely:

FIG. 1 show a flow-chart of the method according to the present invention;

FIG. 2 is a schematic representation of the geometry of a wire rope;

FIG. 3a is a schematic representation of a straight strand subjected to a combination of axial-torsional and bending loads;

FIG. 3b is a schematic representation of a straight strand generalized stresses on the wire cross section;

FIG. 4 is a graph showing a cross sectional bending response of the rope to the mechanical model of the rope.

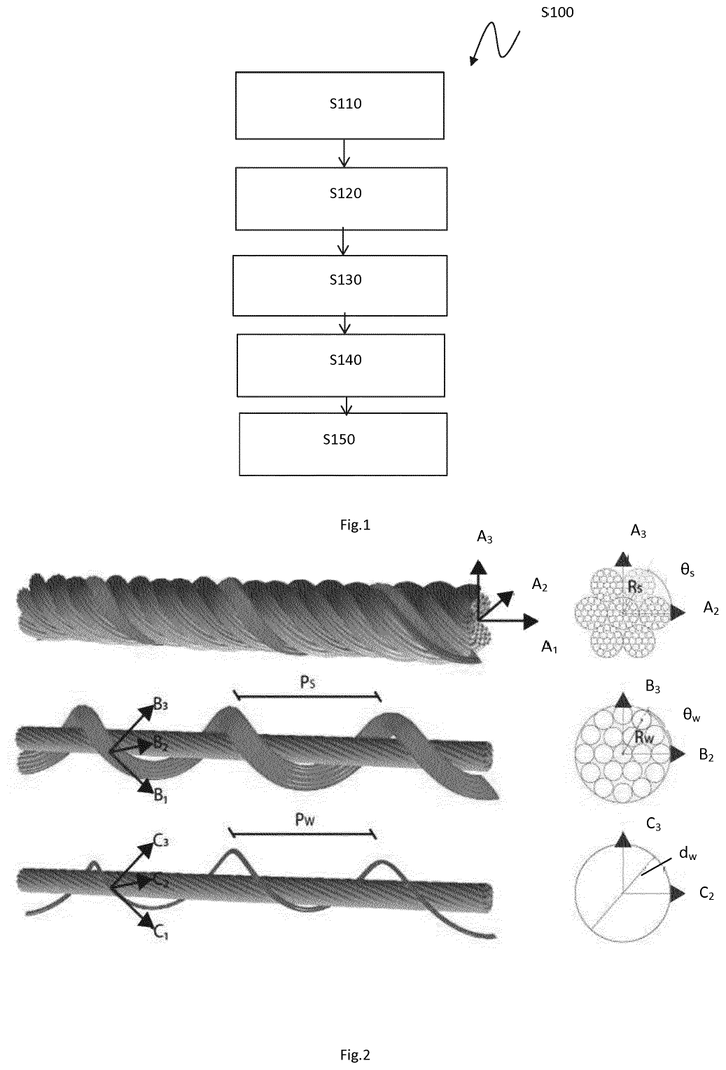

### DETAILED DESCRIPTION OF THR PREFERRED EMBODIMENT

A method for evaluating temperatures in active heave compensation ropes has been defined correlating mechanical models and thermal models. The calibration of the model has been carried out by performing a huge experimental campaign. Set up tests have been done combining inputs (Loads, speeds, D/d), with the scope to determine the wire rope's internal and external thermal variation (ΔT) with respect to the environment temperature. Referring now to the drawings and in particular to FIGS. 1, the method S100 for evaluating temperatures in active heave compensation ropes consists of the following chronological steps:
S110 describe the geometry of wire ropes as composite structures obtained through assemblies of helical components in hierarchical levels: wires, strands and the rope itself;
S120 use a mechanical model of the strand that represents the material properties of each wire, under the assumption of linear elastic behavior;
S130 use a mechanical model of the rope that represents the combined action of the tensile load and of the imposed bending curvature;
S140 use a thermal model for the evaluation of the rope temperature Ts with respect to the ambient temperature, the thermal model comprising two main dissipation sources: the friction between strands or rope and a sheave and the friction between wires or between strands;
S150 compare temperature Tₛ obtained by the thermal model with a value of a predetermined temperature threshold.

The geometry of wire ropes has a composite structures obtained through assemblies of helical components in hierarchical levels: the strands are helically twisted and grouped in concentric layers to form the rope and the same process forms the strands from the wires. The internal structure of the rope is completely defined by the centerline and the orientation of the transversal section of every element at each level. As an example, with reference to the wire rope in FIG. 1, the following levels can be identified: wires, strands and the rope itself, and on each element a local reference system can be defined by the Serret-Frenet unit vectors. The strand centerline is described by a cylindrical helix in the frame of reference of the rope while a wire centerline is described by a cylindrical helix in the frame of the strand (and by a double, or nested, helix in the frame of the rope). The position and orientation of a component cross section in the frame of the component at the higher hierarchical level is hence completely defined as a function of two construction parameters (the helix radius R and the pitch P) and of the swept angle θ. In particular, for a wire in a strand, the three parameters are referenced as Rw, Pw and θW for a wire in a strand, while are referenced as Rs, Ps and θs for a strand in a rope.

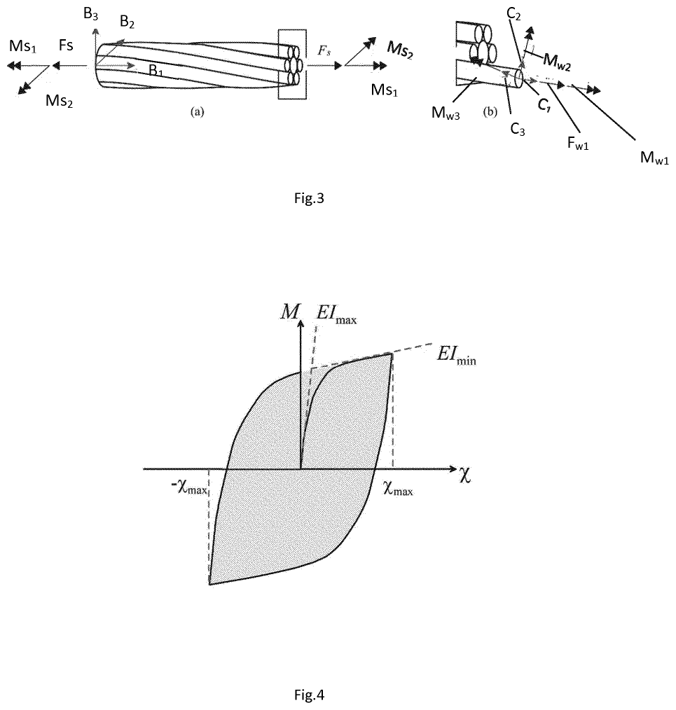

Geometrical parameters of the strands (helix radius Rs, pitch Ps, swept angle θs) are used as starting points to build the mechanical model of the strands. The mechanical model of the strand that is the response of the strand to mechanical loads, is characterized as elastic, and will be evaluated by neglecting friction between the wires and modelling each wire as a curved thin rod, reacting to a combination of axial force, bending and torsional moments (as shown in FIGS. 3a and 3b). The material properties of each wire are fully defined, under the assumption of linear elastic behavior, by specifying the Young modulus E and the Poisson coefficient v.

The stress resultant on the strand cross section is described by introducing the axial force F_{S}, the torsional moment Mₛ₁ and the bending moment Mₛ₂. The generalized strains, work-conjugated to the cross sectional stress resultants of the strand are the axial strain εₛ, the torsional curvature X_{S1}, and the bending curvature Xₛ₂. Without loss of generality, a planar bending problem is herein considered, referring e.g. to for a full discussion of the kinematical assumptions at the base of this formulation and of the case of biaxial bending. By neglecting variations of the internal geometry of the strand, the following linear cross sectional constitutive equations can be introduced:

$$\{ \begin{matrix}{F}_{s} = {EA}_{s} {ɛ}_{s} + {C}_{s} {χ}_{s 1} \\ {M}_{s 1} = {C}_{s} {ɛ}_{s} + {GJ}_{s} {χ}_{s 1} \\ {M}_{s 2} = {EI}_{s} {χ}_{s 2}\end{matrix} \qquad ( 1 )$$

where F_{S} is the axial force, εs is the axial strain, Mₛ₁ is torsional moment, the Ms₂ is the bending moment, the EAₛ, GJₛ and EIₛ denote, respectively, the direct axial, torsional and bending stiffness coefficients—which can be easily determined starting from the above geometrical parameter of the strand (helix radius, pitch and swept angle of a wire in a strand Rw, Pw, θw), −, while Cₛ is the axial-torsional coupling stiffness term, Xₛ₁ is the torsional curvature and Xₛ₂ is the bending curvature.

The mechanical model of the rope is the “two-stage” approximate approach outlined by Cardou, A., Jolicoeur C., “Mechanical Models of Helical Strands”, ASME, Appl. Mech. Rev. 1997, Voi. 50, No. 1, pp. 1-14. It is retained also in this work to model the cross-sectional behavior of a rope subjected to the combined action of the tensile load Fᵣ and of the imposed bending curvature Xᵣ. Accordingly, the solution of the bending problem is superimposed to the initial state of stress and strain due to the tensile load and the following constitutive equations are introduced under the assumption of restrained torsional rotations:

$$\{ \begin{matrix}{F}_{r} = {EA}_{r} {ɛ}_{r} \\ {M}_{r} = {EI}_{min} {χ}_{r} + {M}_{r}^{add} ( {ɛ}_{r} , {χ}_{r} )\end{matrix} \qquad ( 2 )$$

where Fᵣ is the tensile load, Xᵣ is the bending curvature, EAᵣ is the direct axial stiffness of the rope, Elₘᵢₙ is minimum cross sectional bending stiffness of the rope, Mr^{add} is a non-linear contribute to the total bending moment, εᵣ and Mᵣ are the axial strain and the resultant bending moment of the rope, respectively.

The axial behavior is assumed to be independent on the bending curvature and the direct axial stiffness of the rope can be estimated as follows:

$${EA}_{r} = {\sum }_{j = 0}^{m} {n}_{j} {cos}^{3} ( {α}_{s , j} ) {EA}_{s , j} \qquad ( 3 )$$

where: m is the number of layers of the rope; nⱼ is the number of strands belonging to the j-th layer (the index j=0 refers to the core of the rope), and a_{s,j}=tan⁻¹(2πR_{s,j}/P_{s,j}) is the lay angle of the strands in the j-th layer.

Two different contributions to the rope bending moment Mᵣ can be recognized in the equation (2). The first one is linear and independent of the axial strain of the strand. This term is defined taking into account only the individual bending of the strands and can be also regarded as the theoretical response of the rope under the ideal condition of ‘full-slip’, with no friction between the strands (or, in other terms, under the assumption of perfectly lubricated strands).

Accordingly, the subscript ‘min’ is adopted in this work to further highlight that this contribution corresponds to the minimum theoretical value for the cross sectional bending stiffness of the rope. The stiffness coefficient E/ₘᵢₙ, can be defined as:

$${EI}_{min} = {\sum }_{j = 0}^{m} \frac{{n}_{j}}{2} cos ( {α}_{s , j} ) ( sin ( {α}_{s , j} ) {GJ}_{s , j} + ( 1 + {cos}^{2} ( {α}_{s , j} ) ) {EI}_{s , j} ) \qquad ( 4 )$$

The second term in equation (2), Mr^{add}, is non-linear and accounts for the contribution to the total bending moment of the cross section due to the axial force, Fₛ, acting in the individual strands. From simple equilibrium considerations, the following expression can be obtained:

$${M}_{r}^{add} = {\sum }_{j = 0}^{m} {\sum }_{i = 1}^{{n}_{j}} {R}_{s , j} cos ( {α}_{s , j} ) {F}_{s , i} ( {θ}_{s , i} ) sin ( {θ}_{s , i} ) \qquad ( 5 )$$

The axial force acting in the generic strand can be further decomposed into a first contribution, F_{s,a}, due to the axial load Fᵣ, and a second one, F_{s,b}, due to the bending of the strand, i.e.: Fₛ=F_{s,a}+F_{s,b}.

Due to the cylindrical symmetry of the axial-torsional problem with respect to the centerline of the rope, the term F_{s,a} is a constant along the length of the strand (and over all the strands of the same layer).

As long as the friction forces on the external surface are large enough to prevent relative displacements between the strands, i.e. in a strand stick-state [9], the force F_{s,b} can be evaluated as:

F_{s,b}(θₛ)=cos²(αₛ)RₛEAₛ sin(θₛ)xᵣ (6)

The term F_{s,b} generates a gradient of axial force along the strand, as can be easily derived from (6). This gives the strands a tendency to slip with respect to the neighboring ones. This gradient of axial force is resisted by the tangential friction forces acting on the lateral surface of the strand. Whenever the effect of the axial force gradient is greater than the resultant of the tangential friction forces, a strand can undergo a relative displacement with respect to the neighboring ones. A numerical strategy to evaluate the strand axial force F_{s,b}, accounting for the possible transition between a sticking and a slipping regime has been developed by the authors and is adopted also in this work. The numerical procedure is based on a classic Return-Map algorithm, based on a “sticking regime prediction” and a “sliding regime correction”. The Return-Map algorithm delivers the value of the gradient of the strand axial force at a discrete set of control points along the pitch of the strand. Then, the strand axial force is obtained through numerical integration along the strand length.

This friction-based mechanism for the transmission of shearing stresses between the strands makes the bending behavior of the rope non-linear. FIG. 3 shows a typical cross sectional moment-curvature hysteresis loop predicted by the proposed model. A cyclic curvature with limits ±Xₘₐₓ is applied to the cross section. The initial branch is characterized by the initial stiffness EIₘₐₓ, corresponding to the ‘full-stick’ case. The tangent stiffness, then, gradually decreases as a consequence of the evolution of the inter-strand sliding phenomena. Note that Xₘₐₓ is assumed as sufficiently large to achieve the limit value EIₘᵢₙ, which can be attained only if all strands of the cross section are in the slipping state.

Whenever a rope is bent over a sheave having diameter D, three regions can be easily defined according to the value of the curvature of its centerline. In the first one, which is far from the sheave, the rope centerline is straight and its curvature is strictly equal to zero. In the second one, which is on the contact region between the rope and the sheave, the curvature of the rope centerline is constant and can be approximately evaluated as: Xₘₐₓ=2/D. The third region, which is characterized by the transition between the zero curvature and the maximum curvature Xₘₐₓ imposed by the sheave, is neglected in this work. A generic cross-section of the strand passing over the sheave will be considered as bent from zero to the final curvature value Xₘₐₓ. The energy dissipated during the bending of the cross section (dissipated energy per unit length of the strand) can be evaluated as the area Ac enclosed in the hysteresis loop:

A_{c}= [symbol] M_{c}(xᵣ)dxᵣ (7)

The thermal model is based on the fact that whenever a strand or a wire rope is cyclically bent over a sheave, a portion of the total mechanical power provided as input to the system is dissipated through frictional phenomena and transformed in heat. The generated heat is then transmitted through the strand and exchanged with the environment.

Two main dissipation sources can be identified: (1) the friction between the strand (or rope) and the sheave; and (2) the friction between the components of the strand (or rope). The first source of dissipation must be evaluated on a case by case basis. In fact, friction conditions also change as a function of the whole system geometry (e.g. misalignments between rope and sheave, lubrication conditions, sheaves wear status, etc.). Instead, the second one is always present and cannot be ignored, being inherently related to the alternate bending and straightening of the rope cross sections. The heat generation source g can then be estimated simply from the energy Ac(Nm/m) in equation (7), dissipated per unit of length over a full bending cycle (from zero to the curvature Xₘₐₓ imposed by the sheave, and back to zero again). The thermal model for the evaluation of the temperature in the rope with respect to the ambient temperature is represented by an algorithm comprising two main steps:

Step 1—Preliminary calculations:
a. Define the ambient air temperature Ta;
b. Define the air velocity V;
c. Define the air density pf;
d. Define the absolute air viscosity μf;
e. Define rope diameter d;
f. Define the rope coefficient of emissivity e;
g. Define the coefficient of solar absorption a;
h. Define total solar and sky radiated heat Qs;
i. Define the energy dissipated per unit length A_{c}

A_{c}≃2M₀xₘₐₓ

where M₀ is the value of the bending moment of the rope as determined by the mechanical model of the rope, and Xₘₐₓ is the curvature imposed by the sheave.
j. Define the cycle duration t_{c};
k. Evaluate the power generated per unit length of rope g

$$g = \frac{{A}_{c}}{{t}_{c}} ;$$

l. Assume the rope temperature Ts;

Step 2—Iterative computations:
m. Define the rope convected heat loss rate per unit length g_{c}

$${q}_{c} = max \{ {q}_{c 1} , {q}_{c 2} \}$$

$$where \text{:}$$

$${q}_{c 1} = ( 1.01 + 0.371 {( \frac{d {ρ}_{f} V}{{μ}_{f}} )}^{0.52} ) {k}_{f} ( {T}_{s} - {T}_{a} ) , W \text{/} ft$$

$${q}_{c 2} = 0.1695 {( \frac{d {ρ}_{f} V}{{μ}_{f}} )}^{0.60} {k}_{f} ( {T}_{s} - {T}_{a} ) , W \text{/} ft ;$$

and where qc₁ and qc₂ are two empirical formulas for the calculation of the convected heat loss rate per unit length, and K_{f} refers to the thermal conductivity of air;
n. Define the rope radiated heat loss rate per unit length qᵣ

$${q}_{r} = 0.138 {d}^{′} e ( {( \frac{{K}_{s}}{100} )}^{4} - {( \frac{{K}_{a}}{100} )}^{4} ) , W \text{/} ft$$

where d′ is the strand diameter, e is the coefficient of emissivity, and Ks is the strand (average) temperature, Ka is the ambient temperature;
o. Define the solar heat gain per unit length qₛ

qₛ=aQₛ sin(θ)A′

where a is the coefficient of solar absorption, Qs is the total solar and sky radiated heat, q is the effective angle of incidence of the sun rays and A′=d′/12 is the projected area of the strand;
p. Solve equation q_{c}+qᵣ=g+qₛ for the rope temperature Ts;
q. Iterate Step 2 with the new value of the rope temperature Ts computed at the previous step p. until id temperature Ts is stabilized.

The results s. of the predictive tool have two main direct consequences both on the lubricant status, both on the durability of the rope.

The lubricant is characterized by a dropping temperature beyond which it loses its chemical and mechanical characteristics. In this case, the tool permits to simulate if the desired operational conditions lead to exceed that limit or not. Furthermore, the capability of the rope to withstand fatigue stress is direct related to the steel wires mechanical properties (Tensile strength, Yield Strength, elongation at break). As per internal research and well-known scientific literatures, these characteristics can be compromised if the steel wires are extensively exposed to thermal fields. The direct consequence is the loss of ductility, which represents the main parameter for the wire rope fatigue resistance. The monitoring of the rope's thermal status leads to the determination of this loss of ductility and consequently to the estimation of the fatigue resistance variation. In this way, the tool offers the opportunity to understand what and how particular operational conditions could lead to direct consequences into the rope.

Even if at least an embodiment was described in the brief and detailed description, it is to be intended that there exist many other variants in the protection scope of the invention. Further, it is to be intended that said embodiment or embodiments described are only example and do not limit in any way the protection scope of the invention and its application or configurations. The brief and detailed description give instead the experts in the field a convenient guide to implement at least an embodiment, while it is to be intended that many variations of the function and elements assembly here described can be made without departing from the protection scope of the invention encompassed by the appended claims and/or technical/legal equivalents thereof.

1. A method for evaluating temperatures in active heave compensation ropes comprising the following steps:
(S110) describing the geometry of ropes as composite structures obtained through assemblies of helical components in hierarchical levels: wires, strands and the rope itself, the parameters describing the geometry of a rope are the helix radius, the pitch and the swept angle of a wire in a strand (Rw, Pw, θw) and of a strand in a rope (Rs, Ps, θs);
(S120) using a mechanical model of the strand that represents the material properties of each wire, under the assumption of linear elastic behavior, the parameters describing the mechanical behavior of the strand are the axial force (Fₛ), the torsional moment (Mₛ₁) and the bending moment (Mₛ₂);
(S130) using a mechanical model of the rope that represents the combined action of tensile loads and imposed bending curvature, the parameters describing the mechanical behavior of the rope are the tensile load Fr and the bending moment (Mᵣ);
S140) using a thermal model for the evaluation of the rope temperature (Ts) with respect to the ambient temperature, the thermal model comprising two main dissipation sources: the friction between strands or rope and a sheave and the friction between wires or between strands;
(S150) comparing rope temperature (Ts) obtained by the thermal model with a value of a predetermined temperature threshold.

2. The method according to claim 1,
wherein the mechanical model of the strand is calculated by linear cross sectional constitutive equations:
$$\{ \begin{matrix}{F}_{s} = {EA}_{s} {ɛ}_{s} + {C}_{s} {χ}_{s 1} \\ {M}_{s 1} = {C}_{s} {ɛ}_{s} + {GJ}_{s} {χ}_{s 1} \\ {M}_{s 2} = {EI}_{s} {χ}_{s 2}\end{matrix}$$
where Fₛ is the axial force, εₛ is the axial strain, Mₛ₁ is torsional moment, the Mₛ₂ is the bending moment, the EAₛ, GJₛ and EIₛ denote, respectively, the direct axial, torsional and bending stiffness coefficients determined starting from helix radius, pitch and swept angle of a wire in a strand (Rw, Pw, θw), while Cₛ is the axial-torsional coupling stiffness term, xₛ₁ is the torsional curvature and xₛ₂ is the bending curvature.

3. The method according to claim 1, wherein the mechanical model of the rope is calculated by the constitutive equation:
$$\{ \begin{matrix}{F}_{r} = {EA}_{r} {ɛ}_{r} \\ {M}_{r} = {EI}_{min} {χ}_{r} + {M}_{r}^{add} ( {ɛ}_{r} , {χ}_{r} )\end{matrix}$$
where Fᵣ is the tensile load, Xᵣ is the bending curvature, EAᵣ is the direct axial stiffness of the rope, EIₘᵢₙ is the minimum theoretical value for the cross sectional bending stiffness of the rope, Mr^{add} is a non-linear contribute to the total bending moment, εᵣ and Mᵣ are the axial strain and the resultant bending moment of the rope, respectively.

4. The method according to claim 3, wherein the direct axial stiffness of the rope is estimated as follows:
$${EA}_{r} = {\sum }_{j = 0}^{m} {n}_{j} {cos}^{3} ( {α}_{s , j} ) {EA}_{s , j}$$
where m is the number of layers of the rope, nⱼ is the number of strands belonging to the j-th layer, the index j=0 refers to the core of the rope, and α_{s,j}=tan−1(2πR_{s,j}/P_{s,j}) is the lay angle of the strands in the j-th layer.

5. The method according to claim 3 wherein said minimum theoretical value for the cross sectional bending stiffness of the rope (EIₘᵢₙ) has a stiffness coefficient defined as:
$${EI}_{min} = {\sum }_{j = 0}^{m} \frac{{n}_{j}}{2} cos ( {α}_{s , j} ) ( sin ( {α}_{s , j} ) {GJ}_{s , j} + ( 1 + {cos}^{2} ( {α}_{s , j} ) ) {EI}_{s , j} )$$

6. The method according to any of claim 3, wherein Mᵣ^{add} is a non-linear and accounts for the contribution to the total bending moment of the cross section due to the axial force (Fₛ) acting in the individual strands, and is defined as:
$${M}_{r}^{add} = {\sum }_{j = 0}^{m} {\sum }_{i = 1}^{{n}_{j}} {R}_{s , j} cos ( {α}_{s , j} ) {F}_{s , i} ( {θ}_{s , i} ) sin ( {θ}_{s , i} )$$
where Fₛ=F_{s,a}+F_{s,b} and F_{s,a}, is due to the axial load Fᵣ and, the strand axial force F_{s,b}, is due to the bending of the strand and θₛ is the torsional curvature.

7. The method according to claim 6, wherein said strand axial force F_{s,b} is evaluated as:
F_{s,b}(θₛ)=cos²(αₛ)Rₛ EAₛ sin(θₛ)xᵣ
where Xᵣ is the bending curvature.

8. The method according to claim 1, wherein the thermal model comprises a preliminary calculation for the evaluation of the temperature in the rope, said preliminary calculation comprising the following steps:
a. Defining the ambient air temperature (Tₐ);
b. Defining the air velocity (V);
c. Defining the air density (ρ_{f});
d. Defining the absolute air viscosity (μ_{f});
e. Defining rope diameter (d);
f. Defining the rope coefficient of emissivity (e);
g. Defining the coefficient of solar absorption (a);
h. Defining total solar and sky radiated heat (Qₛ);
i. Defining the energy dissipated per unit length (A_{c})
A_{c}≃
where M₀ is the value of the bending moment of the rope and Xₘₐₓ is the curvature imposed by the sheave;
j. Defining the cycle duration (t_{c});
k. Evaluating the power generated per unit length of rope (g)
$$g = \frac{{A}_{c}}{{t}_{c}}$$
l. Evaluating the rope temperature (Tₛ).

9. The method according to claim 8, wherein the thermal model comprises iterative computations to stabilize the temperature in the rope, said iterative computations comprise the following steps:
m. Defining the rope convected heat loss rate per unit length (q_{c})
$${q}_{c} = max \{ {q}_{c 1} , {q}_{c 2} \}$$
$$Where \text{:}$$
$${q}_{c 1} = ( 1.01 + 0.371 {( \frac{d {ρ}_{f} V}{{μ}_{f}} )}^{0.52} ) {k}_{f} ( {T}_{s} - {T}_{a} )$$
$${q}_{c 2} = 0.1695 {( \frac{d {ρ}_{f} V}{{μ}_{f}} )}^{0.60} {k}_{f} ( {T}_{s} - {T}_{a} )$$
and where q_{c1} and q_{c2} are two empirical formulas for the calculation of the convected heat loss rate per unit length and K_{f} refers to the thermal conductivity of air.
n. Defining the rope radiated heat loss rate per unit length (qr)
$${q}_{r} = 0.138 {d}^{′} e ( {( \frac{{K}_{s}}{100} )}^{4} - {( \frac{{K}_{a}}{100} )}^{4} )$$
where d′ is the strand diameter, Kₛ is the strand (average) temperature and Ka is the ambient temperature;
o. Defining the solar heat gain per unit length (qₛ)
qₛ=aQₛ sin(θ)A′
where a is the coefficient of solar absorption, Qs is the total solar and sky radiated heat, q is the effective angle of incidence of the sun rays and A′=d′/12 is the projected area of the strand;
p. Solving equation q_{c}+qᵣ=g+qₛ for the rope temperature (Tₛ);
q. Iterating steps from m. to p. with the new value of the rope temperature (Tₛ) computed at the previous step p. until id temperature (Tₛ) is stabilized.
